(19) United States
(12) Patent Application Publication
(10) Pub. No.: US 2026/0260305 A1
(43) Pub. Date: Sep. 3, 2026

(54) SYSTEM

(71) Applicant: SOFTBANK GROUP CORP., Tokyo (JP)

(72) Inventor: Satoko WATANABE, Tokyo (JP)

(73) Assignee: SOFTBANK GROUP CORP., Tokyo (JP)

(21) Appl. No.: 19/554,731

(22) Filed: Mar. 3, 2026

Related U.S. Application Data
(60) Provisional application No. 63/766,236, filed on Mar. 3, 2025.

(51) Int. Cl. G06Q 50/14; G01C 21/34; G06Q 10/02

(52) U.S. Cl. CPC G06Q 50/14; G01C 21/343; G06Q 10/025

(57) ABSTRACT

A system that streamlines a user's travel planning and provides a personalized travel experience is disclosed. The user inputs information such as past destinations, hobbies, travel period, number of people, and companions via a terminal and transmits this to a server. An analysis unit on the server analyzes the user's travel preferences based on this information and collects data on the destination's climate, culture, and events. The plan generation unit generates an optimal travel plan for the user based on the analysis results, proposing flights, accommodations, tourist attractions, restaurants, clothing, budget, simple greetings, limited-time events, etc. The information presentation unit displays the generated plan as an itinerary on the terminal and introduces reservation sites, supporting users in efficiently planning and executing their trips. This system aims to reduce the complexity of travel planning and enhance user satisfaction.

### CROSS-REFERENCE TO RELATED APPLICATION

This application claims priority under 35 U.S.C. § 119 to U.S. Provisional Patent Application No. 63/766,236, filed on March 3, 2025, the entire contents of which are incorporated herein by reference.

### BACKGROUND

### Technical Field

The present disclosure relates to a system.

### Related Art

Japanese Patent Application Publication Laid-Open (JP-A) No. 2022-180282 discloses a persona chatbot control method performed by at least one processor, comprising: a step of receiving a user utterance; a step of adding to the user utterance a prompt containing a description of the chatbot's persona and related instructions; a step of encoding the prompt; and a step of inputting the encoded prompt into a language model to generate a chatbot utterance in response to the user utterance.

### SUMMARY

System and method to streamline the complex and time-consuming process of travel planning and provide a personalized travel experience is disclosed. Traditionally, planning a trip required individually researching and manually combining numerous elements: selecting destinations, booking flights and accommodations, choosing attractions and restaurants, managing budgets, and preparing for local culture and climate. This process was extremely time-consuming and particularly difficult when destination information was scarce or language barriers existed.

Furthermore, creating plans tailored to individual travelers' specific needs and preferences was difficult using traditional methods, often forcing reliance on generic, standardized plans based on general information. This could result in travelers experiencing trips that did not fully align with their interests or desires, potentially lowering satisfaction.

This invention solves these challenges by having AI automatically generate optimal travel plans based on the user's past travel history, hobbies, travel purpose, and information about traveling companions. The AI collects the latest travel information in real time and proposes flights, accommodations, tourist attractions, restaurants, events, and more tailored to the user's individual needs.

Furthermore, by providing comprehensive support for the entire trip, including budget management and simple greetings for use locally, it creates an environment where travelers can enjoy their trip with peace of mind. In this way, it aims to achieve efficient and personalized travel planning, thereby enhancing traveler satisfaction.

As a means to solve the problem, a system comprising a user information registration unit, an analysis unit, a plan generation unit, and an information presentation unit is provided. The user information registration unit receives information about the user's past travel destinations, hobbies, travel period, number of people, and companions, and has the function of storing this in a database. This information is used as foundational data to understand the user's travel preferences and tendencies.

The analysis unit performs detailed analysis of the user's travel preferences based on the information stored in the database. Furthermore, it has the capability to collect real-time information on the destination's climate, culture, and events, providing the latest information tailored to the user's needs. This analysis forms the foundation for creating the optimal travel plan for the user.

The plan generation unit automatically generates the optimal travel plan for the user based on the analysis results from the analysis unit. This plan includes suggestions for flights, accommodations, tourist attractions, restaurants, clothing, budget, simple greetings, and limited-time events tailored to the user's preferences and budget. This enables the user to enjoy a personalized travel experience.

The information presentation unit has the function of presenting the generated travel plan to the user in the form of an itinerary. Furthermore, it supports the user in making reservations efficiently by introducing reservation sites based on the user's priorities. In this way, it reduces the complexity of travel planning and enables the provision of an optimal travel experience for the user.

### BRIEF DESCRIPTION OF THE DRAWINGS

FIG. 1 is a conceptual diagram showing an example configuration of the data processing system according to the first embodiment.

FIG. 2 is a conceptual diagram showing an example of key functions of the data processing device and smart device according to the first embodiment.

FIG. 3 is a conceptual diagram showing an example configuration of the data processing system according to the second embodiment.

FIG. 4 is a conceptual diagram showing an example of the main functions of the data processing device and smart glasses according to the second embodiment.

FIG. 5 is a conceptual diagram showing an example configuration of a data processing system according to a third embodiment.

FIG. 6 is a conceptual diagram showing an example of the main functions of the data processing device and headset-type terminal according to the third embodiment.

FIG. 7 is a conceptual diagram showing an example configuration of a data processing system according to the fourth embodiment.

FIG. 8 is a conceptual diagram showing an example of the main functions of the data processing device and robot according to the fourth embodiment.

FIG. 9 shows an emotion map onto which multiple emotions are mapped.

FIG. 10 shows an emotion map onto which multiple emotions are mapped.

### DETAILED DESCRIPTION

The following describes an example embodiment of a system according to the present disclosure with reference to the accompanying drawings.

First, the terminology used in the following description is explained.

In the following embodiments, a processor (hereinafter simply referred to as a "processor") may be a single arithmetic unit or a combination of multiple arithmetic units. Furthermore, the processor may be a single type of arithmetic unit or a combination of multiple types of arithmetic units. Examples of processing units include a CPU (Central Processing Unit), a GPU (Graphics Processing Unit), a GPGPU (General-Purpose Computing on Graphics Processing Units), an APU (Accelerated Processing Unit), and the like.

In the following embodiments, signed RAM (Random Access Memory) is a memory where information is temporarily stored and is used as working memory by the processor.

In the following embodiments, the signed storage is one or more non-volatile storage devices that store various programs and various parameters, etc. The non-volatile storage devices examples include flash memory (SSD (Solid- -State Drive)), magnetic disks (e.g., hard disks), or magnetic tapes.

In the following embodiments, the communication I/F (Interface) is an interface including a communication processor and an antenna, etc. The communication I/F governs communication between multiple computers. Examples of communication standards applicable to the communication I/F include wireless communication standards such as 5G (5th Generation Mobile Communication System), Wi-Fi (registered trademark), or Bluetooth (registered trademark).

In the following embodiments, "A and/or B" is synonymous with "at least one of A and B." That is, "A and/or B" means it may be only A, only B, or a combination of A and B. Furthermore, in this specification, when three or more items are expressed connected by "and/or,"

the same concept applies as for "A and/or B".

### First Embodiment

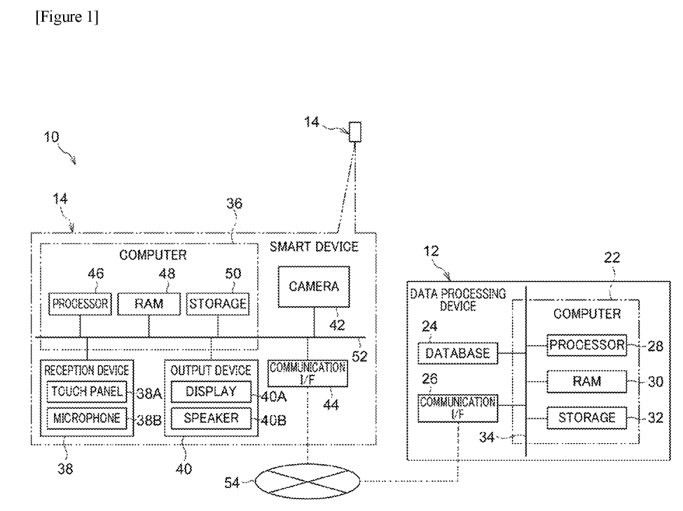

FIG. 1 shows an example configuration of the data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52. are connected to a bus 52. The reception device 38, output device 40, and camera 42 are also connected to the bus 52.

The reception device 38 includes a touch panel 38A and a microphone 38B, among other components, and receives user input. The touch panel 38A receives user input via contact with an indicator (e.g., a pen or finger) by detecting such contact. The microphone 38B receives voice-based user input by detecting the user's voice. The control unit 46A transmits data indicating the user input received via the touch panel 38A and microphone 38B to the data processing unit 12. Within the data processing unit 12, the specific processing unit 290 acquires the data indicating the user input.

The output device 40 includes a display 40A and a speaker 40B, among other components. It presents data to the user 20 by outputting it in a form perceptible to the user 20 (e.g., audio and/or text). The display 40A displays visual information such as text and images according to instructions from the processor 46. The speaker 40B outputs audio according to instructions from the processor 46. The camera 42 outputs audio according to instructions from the processor 46. The camera 42 is a compact digital camera equipped with an optical system, including a lens, aperture, and shutter, and an imaging element, such as a CMOS (Complementary Metal-Oxide-Semiconductor) image sensor or a CCD (Charge Coupled Device) image sensor.

The communication I/F 44 is connected to the network 54. The communication I/F 44 and 26

manage the exchange of various information between processor 46 and processor 28 via network 54.

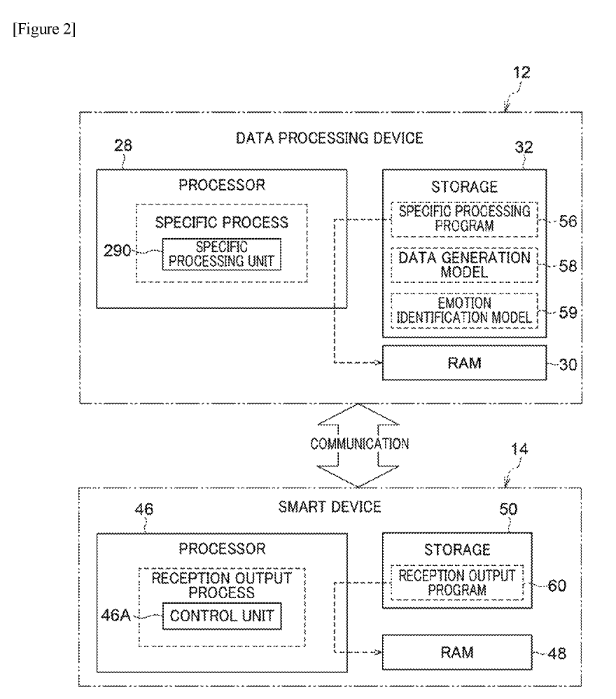

FIG. 2 shows an example of the main functions of the data processing device 12 and the smart device 14.

As shown in FIG. 2, specific processing is performed by processor 28 in data processing device 12. Specific processing program 56 is stored in storage 32. Specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

The smart device 14 performs reception output processing via the processor 46. The reception output program 60 is stored in the storage 50. The reception output program 60 is used in conjunction with the specific processing program 56 by the data processing system 10. The processor 46 reads the reception output program 60 from the storage 50 and executes the read reception output program 60 on the RAM 48. The specific processing is performed by the processor 46 operating as a control unit 46A according to the specific processing program 60 executed on the RAM 48. Note that the smart device 14 may also have data generation models and emotion identification models similar to the data generation model 58 and emotion identification model 59, and may perform processing similar to that of the specific processing unit 290 using these models. The reception output processing is realized by the processor 46 operating as the control unit 46A according to the reception output program 60 executed on the RAM 48.

Other devices besides the data processing device 12 may also have the data generation model 58. For example, a server device (e.g., a generation server) may have the data generation model 58. In this case, the data processing device 12 communicates with the server device having the data generation model 58 to obtain processing results (such as prediction results) obtained using the data generation model 58. Furthermore, the data processing device 12 may be the server device itself, or it may be a terminal device owned by a user (e.g., a mobile phone, robot, home appliance, etc.). Next, an example of processing by the data processing system 10 according to the first embodiment will be described.

### Example 1

The flow of the specific processing in Example 1 is described below. The components of the system described below are implemented by the data processing device 12 and the smart device 14. The data processing device 12 is referred to as the "server," and the smart device 14 is referred to as the "terminal."

### Implementation Examples for Carrying Out the Invention

The embodiment for implementing the present invention will now be described in further detail. This system is realized on both the server and the terminal, with each component performing its respective role to provide the user with a personalized travel plan.

First, the user information registration unit is implemented on the terminal. Users input information via a dedicated application or web interface using terminals such as smartphones, tablets, or PCs. Specifically, users can select a list of countries or cities they have visited in the past and describe their hobbies and interests in detail. For example, if a user enjoys outdoor activities, they can select specific activities like hiking, camping, or skiing. They also select travel purposes such as sightseeing, business, relaxation, or cultural experiences, and input travel duration and companion information (e.g., family, friends, business partners). This information is securely transmitted from the terminal to the server and stored in the database.

Next, the analysis unit is implemented on the server. The server uses advanced algorithms to analyze the user's travel preferences in detail based on the user information stored in the database. For example, it identifies regions or activities the user is particularly interested in based on past travel history and proposes new destinations accordingly. The server also retrieves climate information for the destination via the internet and provides weather forecasts for the travel period. Furthermore, it collects information on local cultural customs and special events occurring during the travel period (e.g., music festivals, local festivals, sporting events), providing up-to-date information tailored to the user's needs.

The plan generation unit is also implemented on the server. Based on the analysis results from the analysis unit, the server automatically generates the optimal travel plan for the user. This plan includes suggestions for flights, accommodations, tourist attractions, restaurants, clothing, budget, simple greetings, and limited-time events, all tailored to the user's preferences and budget. For example, if the user prioritizes budget, it suggests the most cost-effective flights and accommodations; if the user is interested in gourmet dining, it recommends restaurants serving local specialty dishes. Additionally, it provides clothing advice suited to the destination's climate and includes simple greeting phrases for use locally (e.g., "Hello," "Thank you," "Excuse me, could you tell me how to get to...").

The information presentation component is implemented on the terminal device. The generated travel plan is presented to the user on the terminal in the form of an itinerary. Users can review the detailed itinerary via the terminal, understanding each day's schedule, transportation methods, and reservation details. For example, the itinerary includes daily sightseeing schedules, necessary transportation (e.g., trains, buses, taxis), and details of booked flights and accommodations. Furthermore, reservation sites are also introduced on the terminal based on the user's preferences. For example, sites offering low-cost reservations are suggested to cost-conscious users, while sites popular with families are introduced to users seeking family-friendly options.

In this way, the coordinated operation of the server and terminal enables the provision of efficient, personalized travel plans to users, reducing the complexity of travel planning and enhancing user satisfaction. This system aims to achieve flexible responses tailored to diverse user needs, thereby enriching and enhancing the travel experience.

### System Configuration

The system according to this embodiment comprises a user information registration unit, an analysis unit, a plan generation unit, and an information presentation unit. The user information registration unit provides an interface for users to input information regarding countries and cities they have visited in the past, their hobbies, travel duration, number of people, and traveling companions. This interface operates on devices such as smartphones, tablets, and personal computers and is designed to allow users to easily input information. Specifically, users can utilize dropdown menus to select countries and cities they have visited in the past, and text boxes to describe their hobbies and interests. Additionally, checkboxes are provided for selecting travel purposes such as sightseeing, business, relaxation, or cultural experiences. Information regarding the travel period and companions can be entered in a calendar format, with options such as family, friends, or business partners available. This information is securely transmitted from the device to the server and stored in a database.

The analysis unit operates on the server and performs detailed analysis of the user's travel preferences based on the user information stored in the database. The analysis unit uses advanced algorithms to identify regions and activities the user is particularly interested in, based on past travel history. For example, it analyzes countries the user has visited in the past, focusing on places where they stayed for extended periods or cities they visited frequently, and uses this to suggest new travel destinations. Furthermore, the analysis unit retrieves climate information for travel destinations via the internet and provides weather forecasts for the travel period. It also collects information on local cultural customs and special events occurring during the travel period, delivering up-to-date information tailored to the user's needs. For instance, it gathers information on music festivals, local festivals, sports events, etc., and suggests them based on the user's interests.

The Plan Generation Unit automatically generates the optimal travel plan for the user based on the analysis results from the Analysis Unit. It creates a travel plan that includes suggestions for flights, accommodations, tourist attractions, restaurants, clothing, budget, simple greetings, and limited-time events, all tailored to the user's preferences and budget. For example, if the user prioritizes budget, it suggests the most cost-effective flights and accommodations. If the user is interested in gourmet dining, it recommends restaurants serving local specialty dishes. If the user is interested in gourmet dining, it recommends restaurants serving local specialty dishes. It also provides clothing advice suited to the destination's climate and includes simple greeting phrases for use locally. Specific examples of prompt sentences fed to the generative AI include: "Please suggest the optimal destinations and activities based on the user's travel history and hobbies," and "Please select flights and accommodations according to the user's budget."

The information display unit presents the generated travel plan to the terminal in the form of an itinerary. Users can review the detailed itinerary via the terminal, understanding each day's schedule, transportation methods, and reservation details. The itinerary includes daily sightseeing schedules, necessary transportation for travel, and details of booked flights and accommodations. Furthermore, booking sites are recommended on the device based on the user's preferences. For example, cost-conscious users are suggested sites offering affordable bookings, while users seeking family-friendly options are introduced to sites popular with families. In this way, the information presentation unit supports users in efficiently planning and executing their trips.

### Implementation Steps

### Step 1: User Information Registration

Users input information via a dedicated application or web interface using devices such as smartphones, tablets, PC application or web interface. In this step, the user enters detailed information about countries and cities visited in the past, hobbies, travel period, number of people, and information about companions. Specifically, the user uses dropdown menus to select countries and cities visited in the past and text boxes to describe hobbies and interests. They also select the purpose of travel (e.g., sightseeing, business, relaxation, cultural experience) and input the travel period and information about traveling companions in a calendar format. This information is securely transmitted from the device to the server and stored in the database.

### Step 2: Analysis of User Information

An analysis unit operating on the server performs a detailed analysis of the user's travel preferences based on the user information stored in the database. In this step, advanced algorithms are used to identify regions and activities the user is particularly interested in, based on past travel history. For example, it analyzes countries the user has visited in the past, focusing on places where they stayed for extended periods or cities they visited frequently, and uses this to suggest new travel destinations. It also retrieves climate information for the destination and provides weather forecasts for the travel period. Furthermore, it collects local cultural customs and special events occurring during the travel period, delivering up-to-date information tailored to the user's needs.

### Step 3: Generating Travel Plans

The plan generation unit automatically creates the optimal travel plan for the user based on the analysis results from the analysis unit. This step creates a travel plan that includes suggestions for flights, accommodations, tourist attractions, restaurants, clothing, budget, simple greetings, and limited-time events, all tailored to the user's preferences and budget. For example, if the user prioritizes budget, it suggests the most cost-effective flights and accommodations. If the user is interested in gourmet dining, it recommends restaurants serving local specialty dishes. It also provides clothing advice suited to the destination's climate and includes simple greeting phrases for use locally. Specific examples of prompts fed to the generative AI include: "Suggest the optimal destinations and activities based on the user's travel history and hobbies," and "Select flights and accommodations within the user's budget."

### Step 4: Presenting the Travel Plan

The information presentation unit displays the generated travel plan to the terminal in the form of an itinerary. In this step, the user can review the detailed itinerary via the terminal, understanding each day's schedule, transportation methods, and reservation details. The itinerary includes daily sightseeing schedules, necessary transportation for travel, and details of booked flights and accommodations. Furthermore, booking sites are recommended on the device based on the user's preferences. For example, cost-conscious users are suggested sites offering affordable bookings, while users seeking family-friendly options are introduced to sites popular with families. In this way, the information presentation unit supports users in efficiently planning and executing their trips.

### Specific Use Cases

Consider a user planning a trip with the following preferences. The user wishes to visit a country they have never been to before and enjoys sightseeing at historical buildings and sampling local cuisine as hobbies. The trip duration is one week, and while the budget is limited, the user aims to visit as many tourist spots as possible. Traveling companions include family members, including children, necessitating consideration of family-friendly activities.

In this case, the user uses a device to input this information into the user information registration section via a dedicated application or web interface. Specifically, they select candidate countries to visit the desired country, selecting sightseeing at historical buildings and sampling local cuisine as hobbies. They also input the travel period in calendar format and set a budget ceiling. For travel companion information, they select family and input the children's ages.

Next, the analysis unit performs a detailed analysis of the user's travel preferences based on this information. Based on the user's interests, the analysis unit identifies cities within the selected country that are particularly rich in historical buildings and proposes sightseeing destinations accordingly. It also retrieves weather forecasts for the travel period and provides clothing advice suited to the destination's climate. Furthermore, it collects and proposes information on theme parks and zoos that children can enjoy as family-friendly activities.

The Plan Generation Unit automatically generates the optimal travel plan for the user based on the analysis results from the Analysis Unit. This plan includes flight and accommodation suggestions tailored to the user's budget. For example, it selects flights from cost-effective airlines and hotels offering comprehensive family-friendly services. It also recommends restaurants serving local specialty dishes and includes simple greeting phrases for use locally.

The Information Presentation Unit presents the generated travel plan to the terminal in the form of an itinerary. Users can view the detailed itinerary via the terminal, understanding each day's schedule, transportation methods, and reservation information. The itinerary includes daily sightseeing schedules, necessary transportation for travel, and details of booked flights and accommodations. Furthermore, reservation sites are introduced on the terminal based on the user's priority preferences.

Examples of prompt sentences fed to the generative AI include: "Please suggest optimal travel destinations and activities based on the user's travel history and interests," and "Please select flights and accommodations within the user's budget." This enables users to efficiently plan and execute their trips.

### Application Example 1

The flow of specific processing in Application Example 1 is described below. The components of the system described below are implemented by the data processing device 12 and the smart device 14. The data processing device 12 is referred to as the "server," and the smart device 14 is referred to as the "terminal."

### Implementation Examples for the Present Invention

The embodiment for implementing the present invention is described in further detail below. This system optimizes residents' lives in a smart city and supports the efficient operation of the entire city. The system comprises a user information registration unit, an analysis unit, a plan generation unit, and an information presentation unit. These units operate in coordination to provide residents with personalized life plans.

First, the user information registration unit provides an interface for collecting information from residents. This interface operates on terminals such as smartphones, tablets, or PCs and is designed to allow residents to easily input information. Specifically, residents can use text boxes to input their residence and commute destination, and checkboxes to select hobbies and interests. For example, residents can input detailed information such as the public transportation they use daily, the frequency of private vehicle use, and household electricity consumption. This information is securely transmitted from the device to the server and stored in the database. Furthermore, residents can also input more detailed lifestyle information, such as the usage patterns of household appliances and internet usage patterns. This enables the system to more accurately understand the resident's lifestyle.

Next, the analysis unit operates on the server, conducting detailed analyses of residents' lifestyle patterns based on resident information stored in the database. Using advanced algorithms, the Analysis Department identifies residents' commuting patterns and energy consumption patterns. For example, it analyzes what transportation methods residents use during specific times and when electricity consumption peaks. It also acquires real-time traffic data from sensors and traffic management systems within the city to identify congestion levels during commuting hours and determine optimal routes. Furthermore, it collects energy consumption data from smart meters, analyzes residents' consumption patterns, and provides energy-saving advice. It also gathers information on events held within the city and proposes event participation plans tailored to residents' hobbies and interests. For example, if a resident is interested in music, it provides information on nearby concerts or music festivals and encourages participation.

The Plan Generation Unit automatically generates optimal lifestyle plans for residents based on the analysis results from the Analysis Unit. These plans include the following elements. First is commuting route optimization. Based on real-time traffic data, it proposes the most efficient commuting routes and promotes public transportation use. For example, it suggests alternative routes to avoid congestion or optimal departure times. Next is energy usage optimization. Based on residents' consumption patterns, it provides advice to avoid peak electricity usage, aiming to reduce energy costs. For example, it recommends adjusting appliance usage times to avoid peak electricity consumption periods or using energy-efficient appliances. Furthermore, the event participation plan proposes events tailored to residents' interests and adjusts schedules for participation. For example, it provides information on music festivals, local festivals, sports events, etc., supporting residents to participate efficiently.

The information presentation unit presents the generated lifestyle plans to residents. Residents can view detailed plans via smartphones or computers, understanding daily schedules, transportation methods, and energy usage advice. Furthermore, it provides functions to support event reservations and transportation ticket purchases as needed. For example, it offers links for online event registration and public transportation ticket purchases. In this way, the server and terminal work together to provide residents with efficient, personalized lifestyle plans, aiming to enhance the quality of life in smart cities. This system enables flexible responses to diverse resident needs and allows for the optimal utilization of city-wide resources.

### System Configuration

The system according to this embodiment comprises a user information registration unit, an analysis unit, a plan generation unit, and an information presentation unit. The user information registration unit provides an interface for collecting information from residents. This interface operates on terminals such as smartphones, tablets, or PCs and is designed to allow residents to easily input information. Specifically, residents can use text boxes to input their residence and commute destinations, and checkboxes to select hobbies and interests. For example, residents can input detailed information such as the public transportation they use daily, the frequency of private vehicle use, and household electricity consumption. Furthermore, residents can also input more detailed lifestyle information, such as the usage patterns of household appliances and internet usage patterns. This enables the system to more accurately understand residents' lifestyles.

The analysis unit operates on the server and performs detailed analysis of residents' lifestyle patterns based on resident information stored in the database. The analysis unit uses advanced algorithms to identify residents' commuting patterns and energy consumption patterns. For example, it analyzes how residents use specific modes of transportation during particular times of day and when electricity consumption peaks. It also acquires real-time traffic data from sensors and traffic management systems within the city to identify congestion levels during commuting hours and determine optimal routes. Furthermore, it analyzes the patterns of electricity consumption within households and when electricity consumption peaks. It also acquires real-time traffic data from sensors and traffic management systems within the city to identify congestion levels during commuting hours and determine optimal routes. Furthermore, it collects energy consumption data from smart meters, analyzes residents' consumption patterns, and provides energy-saving advice. Event information held within the city is also collected to propose event participation plans tailored to residents' hobbies and interests. For example, if a resident is interested in music, information about nearby concerts or music festivals is provided to encourage participation.

The Plan Generation Unit automatically generates optimal lifestyle plans for residents based on the analysis results from the Analysis Unit. These plans include the following elements. First is commuting route optimization. Based on real-time traffic data, it proposes the most efficient commuting routes and promotes public transportation use. For example, it suggests alternative routes to avoid congestion or optimal departure times. Next is energy usage optimization. Based on residents' consumption patterns, it provides advice to avoid peak electricity usage, aiming to reduce energy costs. For example, it recommends adjusting appliance usage times to avoid peak electricity consumption periods or using energy-efficient appliances. Furthermore, the event participation plan proposes events tailored to residents' interests and adjusts schedules for participation. For example, it provides information on music festivals, local festivals, sports events, etc., supporting residents to participate efficiently.

The information presentation unit presents the generated lifestyle plans to residents. Residents can view detailed plans via smartphone or computer, understanding daily schedules, transportation methods, and energy usage advice. Furthermore, it provides functions to support event reservations and transportation ticket purchases as needed. For example, it offers links for online event registration and public transportation ticket purchases. In this way, the server and terminal work together to provide residents with efficient, personalized lifestyle plans, aiming to enhance the quality of life in smart cities. This system enables flexible responses to diverse resident needs and allows for the optimal utilization of city-wide resources.

Specific examples of prompts fed to the generative AI include: "Based on residents' transportation data and energy consumption patterns, propose optimal commuting routes and energy-saving advice," and "Create event participation plans tailored to residents' hobbies." This enables the system to make concrete proposals to enrich and streamline residents' lives.

### Implementation Steps

### Step 1: User Information Registration

The user information registration section provides an interface for collecting information from residents. In this step, residents use devices such as smartphones, tablets, or PCs to input information including their residence, commute destination, hobbies, family composition, and energy consumption patterns. Specifically, residents can use text boxes to input their residence and commute destination, and checkboxes to select hobbies and interests. For example, residents can input detailed information such as the public transportation they use daily, the frequency of private vehicle use, and household electricity consumption. This information is securely transmitted from the device to the server and stored in the database.

### Step 2: Information Analysis

The analysis unit operates on the server and performs detailed analysis of residents' lifestyle patterns based on the resident information stored in the database. In this step, advanced algorithms are used to identify residents' commuting patterns and energy consumption patterns. For example, it analyzes what transportation methods residents use during specific time periods and when electricity consumption peaks. It also acquires real-time traffic data from sensors and traffic management systems within the city to identify congestion levels during commuting hours and determine optimal routes. Furthermore, it obtains energy consumption data from smart meters, analyzes residents' consumption patterns, and provides energy-saving advice. It also collects information on events held within the city and proposes event participation plans tailored to residents' hobbies and interests.

### Step 3: Generating Lifestyle Plans

The plan generation unit automatically generates optimal lifestyle plans for residents based on the analysis results from the analysis unit. This step involves optimizing commuting routes, optimizing energy usage, and proposing event participation plans. For example, it proposes the most efficient commuting route based on real-time traffic data, encouraging the use of public transportation. Next, it provides advice based on residents' consumption patterns to avoid peak electricity usage, aiming to reduce energy costs. It also proposes events aligned with residents' interests and adjusts schedules for participation. Specific examples of prompt sentences fed to the generative AI include: "Based on residents' transportation data and energy consumption patterns, propose the optimal commuting route and energy-saving advice," and "Create an event participation plan tailored to residents' hobbies."

### Step 4: Presenting the Lifestyle Plan

The information presentation unit presents the generated lifestyle plan to residents. In this step, residents can view detailed plans via smartphone or computer, understanding daily schedules, transportation methods, and energy usage advice. Additionally, it provides functions to support event reservations and transportation ticket purchases as needed. For example, it offers links for online event registration and public transportation ticket purchases. This enables residents to efficiently plan and execute their daily lives.

### Specific Use Cases

Consider a resident living in a city who wants to manage their daily life more efficiently. This resident aims to shorten their daily commute time, reduce energy costs, and participate in events they can enjoy with their family on weekends. Using this system, the resident inputs information such as their residence, workplace, hobbies, and household energy consumption patterns via their smartphone. For instance, the resident might select public transportation as their commute route from home to work and register music and sports viewing as their hobbies. They would also input household electricity consumption data, such as air conditioner and lighting usage.

Based on this information, the analysis unit conducts detailed analysis of residents' lifestyle patterns. For instance, it obtains real-time data on the crowding levels of the train residents use every morning and suggests the optimal departure time. It also analyzes energy consumption data obtained from smart meters and provides advice on avoiding peak-time electricity usage. Furthermore, based on residents' hobbies, it collects information on music concerts or sports events held on weekends and proposes participation plans.

The Plan Generation Unit generates optimal lifestyle plans for residents based on the analysis results. These plans include commuting route optimization, energy usage optimization, and event participation plans. For example, it suggests alternative routes to avoid crowded trains used for commuting and optimal departure times. It also provides advice on adjusting air conditioner usage times to reduce energy costs. Furthermore, it suggests events aligned with the resident's interests and adjusts schedules for participation.

The information presentation unit presents the generated lifestyle plan to residents. Residents can view detailed plans via their smartphones, understanding daily schedules, transportation methods, and energy usage advice. Furthermore, it provides functions to support event reservations and transportation ticket purchases as needed. For example, it provides links for online event registration and public transportation ticket purchases.

Examples of prompt sentences fed to the generative AI include: "Based on the resident's transportation data and energy consumption patterns, please propose the optimal commuting route and energy-saving advice," or "Please create an event participation plan tailored to the resident's hobbies." In this way, residents can efficiently plan and execute their daily lives.

The specific processing unit 290 transmits the result of the specific processing to the smart device 14. On the smart device 14, the control unit 46A causes the output device 40 to output the result of the specific processing. The microphone 38B acquires audio indicating user input regarding the result of the specific processing. The control unit 46A transmits the audio data indicating the user input acquired by the microphone 38B to the data processing unit 12. At the data processing unit 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned parts is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing by the data processing system 10 described above may be executed by the specific processing unit 290 of the data processing device 12 or the control unit 46A of the smart device 14. Alternatively, the processing may be executed by the specific processing unit 290 of the data processing device 12 and the control unit 46A of the smart device 14. Furthermore, the data processing device 12's specific processing unit 290 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart device 14.

### Second Embodiment

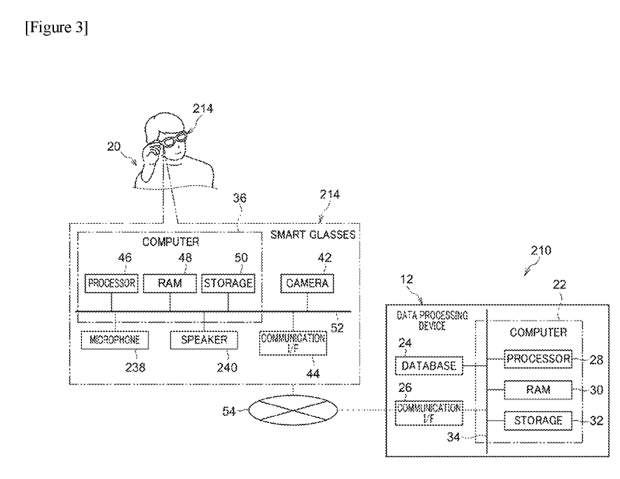

FIG. 3 shows an example configuration of the data processing system 210 according to the second embodiment.

As shown in FIG. 3, the data processing system 210 includes a data processing device 12 and smart glasses 214. An example of the data processing device 12 is a server.

Data processing device 12 includes a computer 22, a database 24, and a communication I/F 26. Computer 22 is an example of a "computer" related to the technology of this disclosure. Computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart glasses 214 include a computer 36, a microphone 238, a speaker 240, a camera 42, and a communication I/F 44. The computer 36 includes a processor 46, RAM 48, and storage 50. Processor 46, RAM 48, and storage 50 are connected to bus 52. Microphone 238, speaker 240, and camera 42 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

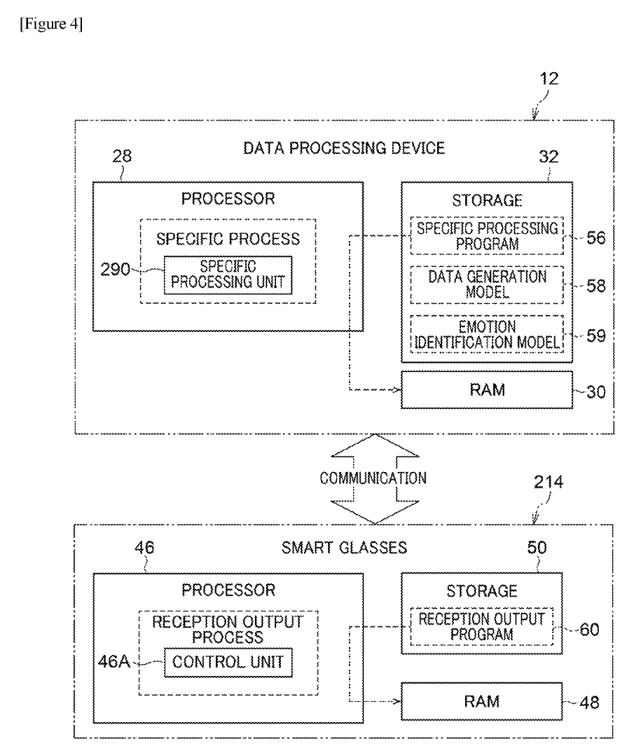

FIG. 4 shows an example of key functions of the data processing device 12 and the smart glasses 214. As shown in FIG. 4, specific processing is performed by the processor 28 in the data processing device 12. The specific processing program 56 is stored in the storage 32.

The specific processing program 56 is an example of a "program" related to the technology of this disclosure. Processor 28 reads the specific processing program 56 from storage 32 and executes the read specific processing program 56 on RAM 30. The specific processing is realized by processor 28 operating as specific processing unit 290 according to the specific processing program 56 executed on RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

In the smart glasses 214, the processor 46 performs the reception output processing. The reception output program 60 is stored in the storage 50. The processor 46 reads the reception output program 60 from the storage 50 and executes the read reception output program 60 on the RAM 48. The reception output processing is realized by the processor 46 operating as the control unit 46A according to the reception output program 60 executed on the RAM 48. Note that the smart glasses 214 may also have a data generation model 58 and an emotion identification model 59, and can perform processing similar to that of the identification processing unit 290 using these models.

Next, the identification processing performed by the identification processing unit 290 of the data processing device 12 is described. The components of the system described below are implemented by the data processing device 12 and the smart glasses 214. In the following description, the data processing device 12 is referred to as the "server," and the smart glasses 214 are referred to as the "terminal."

### Example 1

The flow of the specific processing in Example 1 described in the first embodiment is the same as described above, so the explanation is omitted.

### Application Example 1

The flow of the specific processing in Example 1 described in the first embodiment is the same as above, so the explanation is omitted.

The specific processing unit 290 transmits the result of the specific processing to the smart glasses 214. In the smart glasses 214, the control unit 46A causes the speaker 240 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is a so-called generative AI (Artificial Intelligence). An example of a data generation model 58 is ChatGPT (registered trademark) (Internet search <URL: https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using the generated AI. For example, the provision unit is implemented by the output device 40 of the smart device 14 or the specific processing unit 290 of the data processing device 12 and provides the generated cooking menu. The generation unit is implemented by the specific processing unit 290 of the data processing device 12 and generates a cooking menu using generative AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart glasses 214.

### Third Embodiment

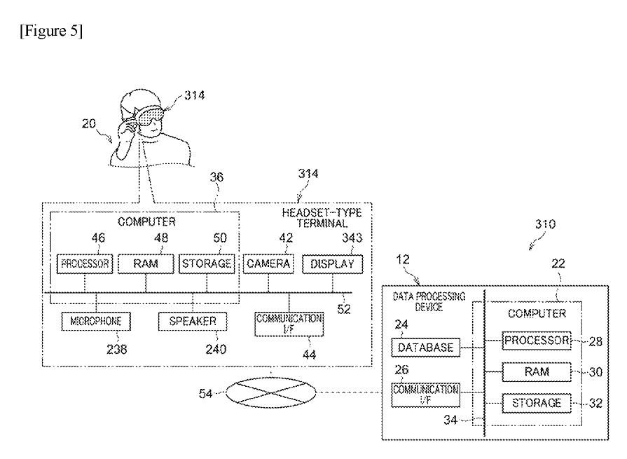

FIG. 5 shows an example configuration of the data processing system 310 according to the third embodiment.

As shown in FIG. 5, the data processing system 310 includes a data processing device 12 and a headset-type terminal 314. An example of the data processing device 12 is a server.

Data processing device 12 includes a computer 22, a database 24, and a communication I/F 26. Computer 22 is an example of a "computer" related to the technology of this disclosure. Computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is include a WAN (Wide Area Network) and/or a LAN (Local Area Network).

The headset-type terminal 314 comprises a computer 36, a microphone 238, a speaker 240, a camera 42, a communication interface 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

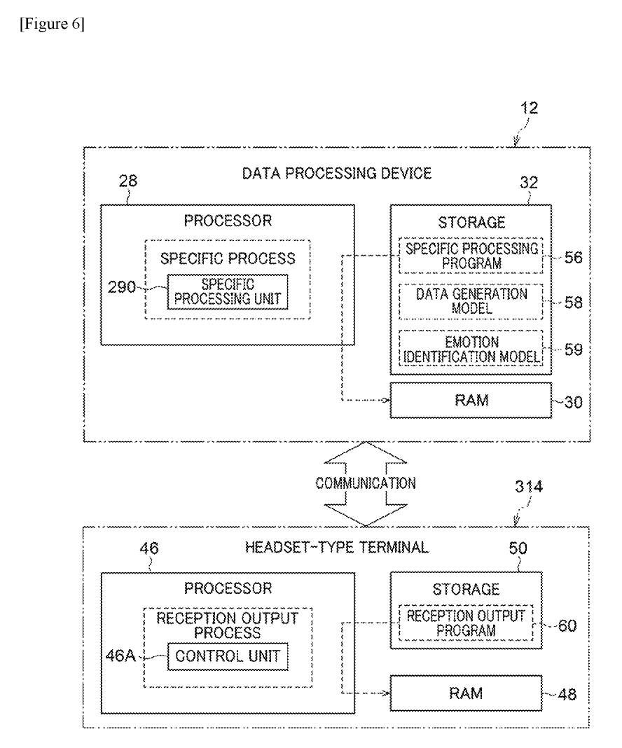

FIG. 6 shows an example of the main functions of the data processing device 12 and the headset-type terminal 314. As shown in FIG. 6, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by the specific processing unit 290.

In the headset-type terminal 314, reception output processing is performed by the processor 46. The reception output program 60 is stored in the storage 50. Processor 46 reads the reception output program 60 from storage 50 and executes the read reception output program 60 on RAM 48. Reception output processing is achieved by processor 46 operating as control unit 46A according to the reception output program 60 executed on RAM 48.

Next, the specific processing performed by the specific processing unit 290 of the data processing device 12 is described. The various parts of the system described below are implemented by the data processing device 12 and the headset-type terminal 314. In the following description, the data processing device 12 is referred to as the "server," and the headset-type terminal 314 is referred to as the "terminal."

### Example 1

The flow of the specific processing is the same as that described in Example 1 of the first embodiment, so the description is omitted.

### Application Example 1

The flow of the specific processing in Example 1 described in the above first embodiment is the same, so the explanation is omitted.

The specific processing unit 290 transmits the result of the specific processing to the headset-type terminal 314. At the headset-type terminal 314, the control unit 46A causes the speaker 240 and the display 343 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is a so-called generative AI (Artificial Intelligence). An example of a data generation model 58 is ChatGPT (registered trademark) (Internet search <URL: https://openai.com/blog/chatgpt>). Data generation model 58 is obtained by performing deep learning on a neural network. Data generation model 58 receives input prompts containing instructions, as well as inference data such as audio data representing sound, text data representing text, and image data (e.g., still image data or video data) representing images. Data generation model 58 infers based on the instructions indicated by the prompt using the input inference data and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the headset-type terminal 314.

### Fourth Embodiment

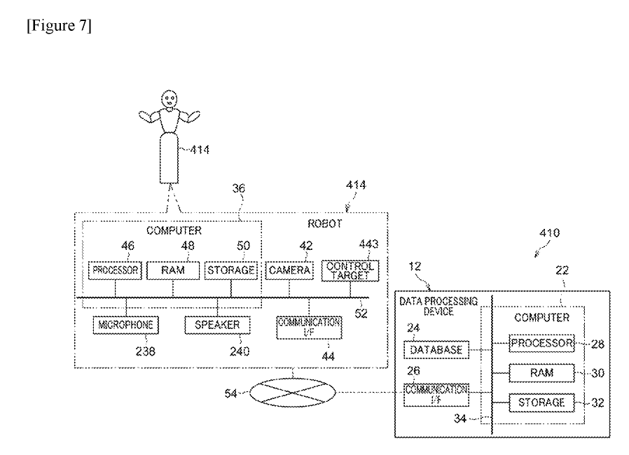

FIG. 7 shows an example configuration of the data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 is an example of a "computer" related to the technology of this disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network) can be done.

Robot 414 includes a computer 36, a microphone 238, a speaker 240, a camera 42, a communication I/F 44, and a control target 443. Computer 36 includes a processor 46, RAM 48, and storage 50. Processor 46, RAM 48, and storage 50 are connected to bus 52. Furthermore, microphone 238, speaker 240, camera 42, and controlled object 443 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

Camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

The control target 443 includes a display device, LEDs for the eye section, and motors for driving the arms, hands, legs, etc. The posture and gestures of robot 414 are controlled by controlling the motors for the arms, hands, legs, etc. Part of the robot 414's emotions can be expressed by controlling these motors. Furthermore, the robot 414's facial expressions can also be expressed by controlling the light emission state of the LEDs in its eyes.

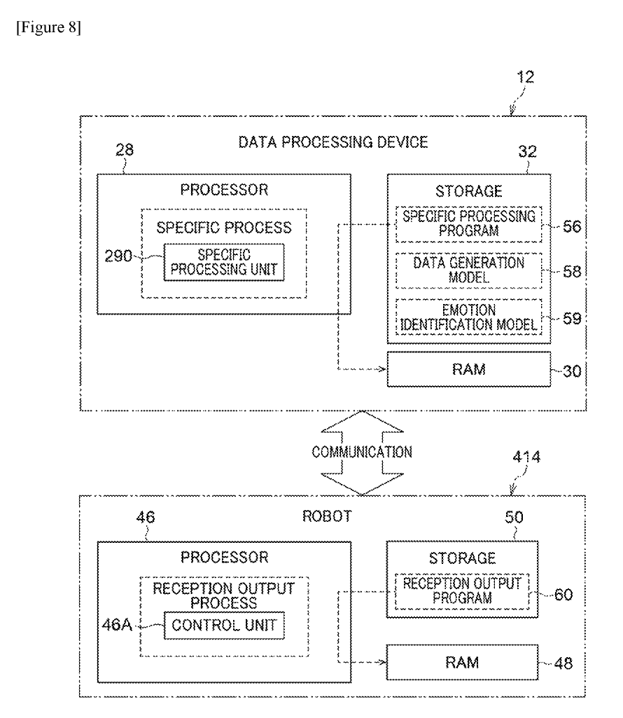

FIG. 8 shows an example of the main functions of the data processing device 12 and the robot 414. As shown in FIG. 8, specific processing is performed by the processor 28 in the data processing device 12. The specific processing program 56 is stored in the storage 32.

The specific processing program 56 is an example of a "program" pertaining to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by the specific processing unit 290.

In robot 414, reception output processing is performed by processor 46. Storage 50 stores a reception output program 60. Processor 46 reads the reception output program 60 from storage 50 and executes the read reception output program 60 on RAM 48. Reception output processing is realized by the processor 46 operating as a control unit 46A according to the reception output program 60 executed on RAM 48.

Next, the specific processing performed by the specific processing unit 290 of the data processing device 12 is described. The various parts of the system described below are realized by the data processing device 12 and the robot 414. In the following description, the data processing device 12 is referred to as the "server," and the robot 414 is referred to as the "terminal."

### Example 1

The flow of the specific processing is the same as that described in Example 1 of the first embodiment, so the description is omitted.

### Application Example 1

The flow of the specific processing in Example 1 described in the above first embodiment is the same, so the explanation is omitted.

The specific processing unit 290 transmits the result of the specific processing to robot 414. In the robot 414, the control unit 46A causes the speaker 240 and the control target 443 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is what is known as generative AI (Artificial Intelligence). An example of a data generation model 58 is ChatGPT (registered trademark) (Internet search <URL: https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNNs), recurrent neural networks (RNN), generative adversarial networks (GAN), or naive Bayes, among others. The AI may perform various processing operations, but is not limited to such examples. AI may also be an AI agent. Furthermore, when processing by the aforementioned components is performed by AI, such processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the robot 414.

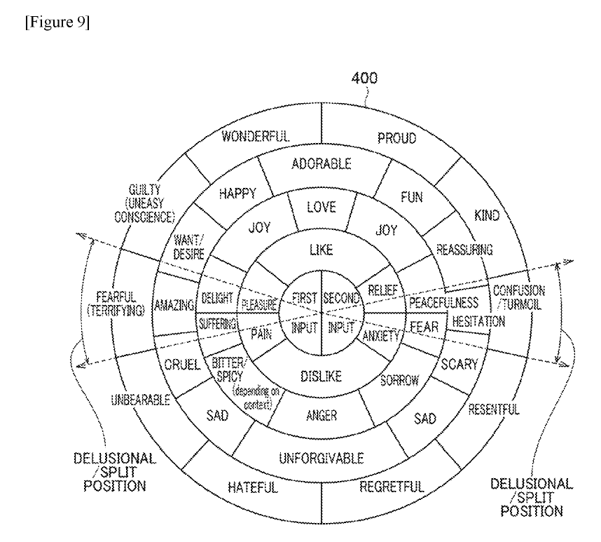

The emotion identification model 59, functioning as an emotion engine, may determine the user's emotion according to a specific mapping. Specifically, the emotion identification model 59 may determine the user's emotion according to an emotion map (see FIG. 9), which is a specific mapping. Furthermore, the emotion identification model 59 may similarly determine the robot's emotion, and the specific processing unit 290 may perform specific processing using the robot's emotion.

FIG. 9 is a diagram showing an emotion map 400 where multiple emotions are mapped. In the emotion map 400, emotions are arranged radially in concentric circles from the center. Emotions closer to the center of the concentric circles represent more primitive states. Emotions representing states or behaviors arising from mental states are arranged further out in the concentric circles. Emotion is a concept encompassing affect and mental states. Generally, emotions generated from reactions occurring within the brain are placed on the left side of the concentric circles. Generally, emotions induced by situational judgment are placed on the right side of the concentric circles. Generally, emotions generated from reactions occurring within the brain and also induced by situational judgment are placed on the upper and lower sides of the concentric circles. Furthermore, the upper part of the concentric circle contains "pleasant" emotions, while the lower part contains "unpleasant" emotions. Thus, the Emotion Map 400 maps multiple emotions based on the structure of their origin, with emotions that tend to occur simultaneously mapped closer together.

These emotions are distributed around the 3 o'clock position on Emotion Map 400, typically oscillating between feelings of security and anxiety. In the right half of Emotion Map 400, situational awareness takes precedence over internal sensations, resulting in a calmer impression.

The inner part of the emotion map 400 represents the mind, while the outer part represents behavior. Therefore, the further out on the emotion map 400, the more visible the emotion becomes (manifesting in behavior).

Here, human emotions are based on various balances, such as posture and blood sugar levels. When these balances deviate from the ideal, it indicates a state of discomfort; when they approach the ideal, it indicates a state of comfort. Similarly, for robots, automobiles, motorcycles, etc., emotions can be created based on various balances, such as posture and battery level. When these balances deviate from the ideal, it indicates a state of discomfort; when they approach the ideal, it indicates a state of comfort. Emotion maps, for example, Dr. Mitsuyoshi's Emotion Map (Based on research on speech emotion recognition and brain physiological signal analysis systems for emotions, Tokushima University, Doctoral Dissertation: https://ci.nii.ac.jp/naid/500000375379). The left half of the emotion map displays emotions belonging to the "Reaction" domain, where sensory aspects predominate. The right half of the emotion map displays emotions belonging to the "situation" domain, where situational awareness is dominant.

Two emotions that promote learning are defined in the emotion map. One is the negative emotion around the center of the "repentance" or "reflection" area on the situation side. That is, when the robot experiences negative emotions like "I never want to feel this way again" or "I don't want to be scolded anymore.” The other is the positive emotion around "desire" on the reaction side. That is, when the robot feels positive emotions like "I want more" or "I want to know more."

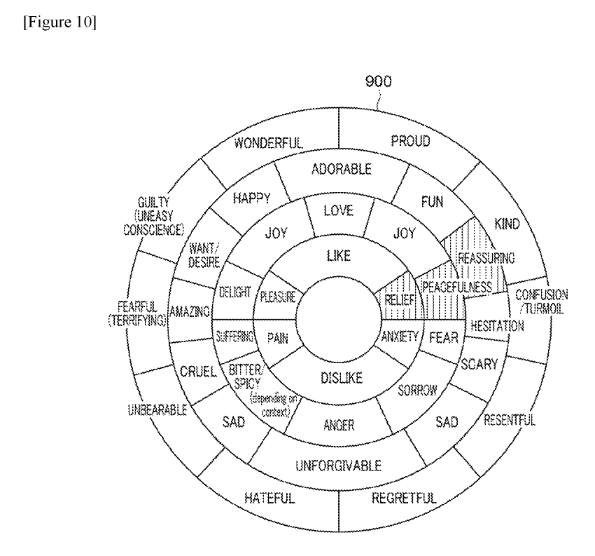

The emotion identification model 59 inputs the user input into a pre-trained neural network, obtains emotion values corresponding to each emotion shown in the emotion map 400, and determines the user's emotion. This neural network is pre-trained based on multiple training data sets, which are combinations of user input and emotion values corresponding to each emotion shown in the emotion map 400. Furthermore, this neural network is trained such that emotions positioned close to each other, as shown in the emotion map 900 in FIG. 10, have similar values. FIG. 10 illustrates an example where multiple emotions, such as "reassurance," "tranquility," and "encouragement," have similar emotion values.

The above description primarily explains the system of the present disclosure in terms of the functions of the data processing device 12. However, the system of the present disclosure is not necessarily implemented on a server. The system of the present disclosure may be implemented as a general information processing system. For example, the present disclosure may be implemented as a software program operating on a personal computer or as an application operating on a smartphone, etc. The method of the present disclosure may be provided to users in a SaaS (Software as a Service) format.

The above embodiments illustrated a configuration where specific processing is performed by a single computer 22. However, the technology of this disclosure is not limited thereto. Distributed processing may be performed by multiple computers, including computer 22, for specific processing. For example, data generation model 58 may be provided in an external device of data processing device 12, and said external device may generate data corresponding to input data.

The above embodiment described a configuration where the specific processing program 56 is stored in the storage 32, but the technology disclosed herein is not limited to this. For example, the specific processing program 56 may be stored on a portable, computer-readable non-volatile storage medium, such as a USB (Universal Serial Bus) memory. The specific processing program 56 stored on the non-volatile storage medium is installed on the computer 22 of the data processing device 12. The processor 28 executes specific processing according to the specific processing program 56.

Alternatively, the specific processing program 56 may be stored on a storage device, such as a server, connected to the data processing device 12 via the network 54. Upon request from the data processing device 12, the specific processing program 56 may be downloaded and installed on the computer 22.

It should be noted that it is not necessary to store the entire specific processing program 56 on a storage device such as a server connected to the data processing device 12 via the network 54, or to store the entire specific processing program 56 in the storage 32. It is also possible to store only a portion of the specific processing program 56.

Various types of processors can be used as hardware resources to execute the specific processing. Examples of processors include a CPU, which is a general-purpose processor that functions as a hardware resource for executing specific processing by executing software, i.e., programs. Additionally, processors may include dedicated electronic circuits, such as FPGAs (Field-Programmable Gate Array), PLDs (Programmable Logic Device), or ASICs (Application Specific Integrated Circuit), which are processors with circuit configurations specifically designed to execute particular processing. Each processor has memory either built-in or connected, and each processor executes specific processing by using this memory.

The hardware resources for executing specific processing may be comprised of one of these various processors, or may be comprised of a combination of two or more processors of the same or different types (e.g., a combination of multiple FPGAs, or a combination of a CPU and an FPGA). Furthermore, the hardware resources for executing specific processing may be a single processor.

Examples of configurations using a single processor include: First, a configuration where one processor is formed by combining one or more CPUs with software, with this processor functioning as the hardware resource executing specific processing. Second, there is a form using a processor that implements the entire system functionality, including multiple hardware resources executing specific processing, on a single IC chip, as exemplified by a System-on-a-chip (SoC). Thus, specific processing is implemented using one or more of the above various processors as hardware resources.

Furthermore, regarding the hardware structure of these various processors, more specifically, electrical circuits combining circuit elements such as semiconductor devices can be used. Also, the specific processing described above is merely one example. Therefore, it goes without saying that within the scope not deviating from the main purpose, unnecessary steps may be omitted, new steps may be added, or the processing order may be changed.

The above description and illustrations provide a detailed explanation of the aspects pertaining to the technology of this disclosure and represent merely one example of the technology disclosed herein. For example, the explanations regarding the configuration, functions, operations, and effects described above are examples of the configuration, functions, operations, and effects pertaining to the aspects of the technology disclosed herein. Therefore, it goes without saying that within the scope of not deviating from the essence of the technology of this disclosure, unnecessary portions may be deleted, new elements may be added, or replacements may be made to the above-described content and illustrated content. Furthermore, to avoid complexity and facilitate understanding of the part pertaining to the technology of this disclosure, descriptions of technical common knowledge, etc., that are particularly unnecessary for enabling the implementation of the technology of this disclosure have been omitted from the above-described content and illustrated content.

All literature, patent applications, and technical specifications cited herein are incorporated by reference to the same extent as if each individual literature, patent application, and technical specification were specifically and individually cited herein.

Regarding the above embodiments, the following is further disclosed.

### Supplementary note 1

A system comprising a user information registration unit, an analysis unit, a plan generation unit, and an information presentation unit, wherein the user information registration unit collects information regarding residents' place of residence, workplace, hobbies, family composition, and energy consumption patterns, and stores this information in a database; the analysis unit analyzes residents' lifestyle patterns based on the information stored in the database, collects real-time traffic data, energy consumption data, and event information, and provides foundational data for generating optimal lifestyle plans for residents; the plan generation unit creates lifestyle plans based on the analysis results from the analysis unit, including commuting routes, energy usage optimization, and event participation plans. The information presentation unit presents the generated lifestyle plans to residents and supports necessary reservations and arrangements.

### Supplementary note 2

The user information registration unit collects information regarding residents' place of residence, commuting destinations, hobbies, family composition, and energy consumption patterns, and stores this information in a database; and the analysis unit analyzes residents' lifestyle patterns based on the information stored in the database, collects real-time transportation data, energy consumption data, and event information, and provides foundational data for generating optimal lifestyle plans for residents energy usage optimization, and event participation plans. The information presentation unit presents the generated lifestyle plan to residents and supports necessary reservations and arrangements.

### Supplementary note 3

The system described in Supplementary note 1, wherein the analysis unit analyzes residents' lifestyle patterns based on information regarding their residence, commute destination, hobbies, family composition, and energy consumption patterns, collects traffic data, energy consumption data, and event information in real time, and provides foundational data for generating optimal lifestyle plans for residents; wherein the plan generation unit creates lifestyle plans based on the analysis results from the analysis unit, including commuting routes, energy usage optimization, and event participation plans. The information presentation unit presents the generated lifestyle plan to residents and provides functions to support necessary reservations and arrangements.

### EXPLANATION OF SYMBOLS

10, 210, 310, 410 Data Processing System

12 Data Processing Device

14 Smart Device

214 Smart Glasses

314 Headset-type devices

414 Robot

What is claimed is:

1. A computer-implemented method for generating a travel plan for a user, comprising:
receiving, via a terminal device, user information including past travel destinations, hobbies, a travel period, a number of travelers, and information regarding travel companions, and storing the user information in a database;
analyzing, by a server, the stored user information to identify travel preferences of the user;
collecting, by the server, destination-related information in real time, the destination-related information including at least climate information, cultural information, and event information corresponding to a destination and the travel period;
generating, by the server using a generative artificial intelligence model, a travel plan based on the identified travel preferences and the collected destination-related information, the travel plan including proposals for flights, accommodations, tourist attractions, restaurants, clothing guidance, budget information, simple greeting phrases, and event information; and
presenting the generated travel plan to the user via the terminal device in the form of an itinerary, and introducing reservation sites corresponding to elements of the travel plan based on user priorities.

2. The method of claim 1, wherein the analyzing includes evaluating relationships between the past travel destinations and the hobbies stored in the database.

3. The method of claim 1, wherein the destination-related information includes weather forecast information for the travel period.

4. The method of claim 1, wherein the travel plan includes clothing recommendations corresponding to the climate information.

5. The method of claim 1, wherein the itinerary presents a daily schedule including transportation methods between itinerary elements.

6. The method of claim 1, wherein the reservation sites are introduced based on at least one of cost-conscious preferences or family-oriented preferences indicated by the user information.

7. A travel planning system, comprising:
a terminal device configured to receive user input;
a server comprising one or more processors and a database, the server being configured to execute:
a user information registration unit configured to receive, from the terminal device, user information including past travel destinations, hobbies, travel period, number of travelers, and travel companion information, and to store the user information in the database;
an analysis unit configured to analyze the user information stored in the database to determine travel preferences of the user;
a plan generation unit configured to collect destination-related information in real time and to generate a travel plan using a generative artificial intelligence model based on the travel preferences and the destination-related information; and
an information presentation unit configured to transmit the generated travel plan to the terminal device for display as an itinerary and to introduce reservation sites corresponding to the travel plan.

8. The system of claim 7, wherein the destination-related information includes information regarding local events scheduled during the travel period.

9. The system of claim 7, wherein the plan generation unit generates the travel plan in response to prompt instructions provided to the generative artificial intelligence model.

10. The system of claim 7, wherein the travel plan includes a budget estimate corresponding to flights and accommodations.

11. The system of claim 7, wherein the information presentation unit presents multiple candidate reservation sites for a same travel component.

12. The system of claim 7, wherein the server stores updated user information reflecting user interaction with the presented itinerary.

13. A non-transitory computer-readable medium storing instructions that, when executed by one or more processors of a server, cause the server to:
receive user information including past travel destinations, hobbies, a travel period, number of travelers, and travel companion information from a terminal device and store the user information in a database;
analyze the stored user information to identify travel preferences of a user;
collect destination-related information including climate information, cultural information, and event information in real time;
generate a travel plan using a generative artificial intelligence model based on the travel preferences and the destination-related information, the travel plan including proposals for flights, accommodations, tourist attractions, restaurants, clothing guidance, budget information, simple greeting phrases, and event information; and
output the travel plan to the terminal device for presentation as an itinerary and for introduction of reservation sites.

14. The non-transitory computer-readable medium of claim 13, wherein the destination-related information includes information acquired from external network-based services.

15. The non-transitory computer-readable medium of claim 13, wherein the travel plan includes limited-time event information occurring during the travel period.

16. The non-transitory computer-readable medium of claim 13, wherein the itinerary is presented in a chronological order corresponding to the travel period.

17. The non-transitory computer-readable medium of claim 13, wherein the server updates stored user information based on subsequent user inputs.

18. The non-transitory computer-readable medium of claim 13, wherein the instructions are provided as part of a software-as-a-service travel planning platform.
